(19) United States
(12) Patent Application Publication
(10) Pub. No.: US 2019/0146742 A1
(43) Pub. Date: May 16, 2019

(54) PROVIDING ENRICHED E-READING EXPERIENCE IN MULTI-DISPLAY ENVIRONMENTS

(71) Applicant: Futurewei Technologies, Inc., Plano, TX (US)

(72) Inventors: Changzhu Li, Santa Clara, CA (US); Fei Gao, Mountain View, CA (US); Kwang Nyun Kim, San Jose, CA (US)

(21) Appl. No.: 15/814,324

(22) Filed: Nov. 15, 2017

(51) Int. Cl. G06F 3/14; G06F 3/0483; G06F 3/01; G06F 3/16; G06F 3/0488; G06F 17/24

(52) U.S. Cl. CPC G06F 3/1423; G06F 3/0483; G06F 17/241; G06F 3/16; G06F 3/04883; G06F 3/013

(57) ABSTRACT

A method is described for providing an enriched e-reading experience in a multi-display environment. A multi-display device that includes at least an e-paper display and a multimedia display identifies an enriched e-book source. The enriched e-book source includes text for presenting by the e-paper display and keywords referring to supplemental materials for the text for presenting by the multimedia display. The e-paper display presents at least a first keyword. The first keyword refers to a first supplemental material for a first portion of the text for presenting by the multimedia display. The multi-display device receives a user input that selects to present the first supplemental material for the first keyword. In response to receiving the user input, the multi-display device retrieves the first supplemental material for the first keyword. The multimedia display of the multi-display device presents the first supplemental material for the first keyword.

### TECHNICAL FIELD

This disclosure relates to e-reading, and, more particularly, to e-reading experience in a Multi-Display Environment (MDE).

### BACKGROUND

An e-reader, also called an e-book reader or e-book device, is an electronic device (e.g., a mobile electronic device) for reading digital e-books and periodicals. Generally, any device that can display text on a screen may act as an e-reader. E-reading can refer to e-book reading using an e-reader.

An e-reader typically has an electronic paper (e-paper) display that mimics the appearance of ordinary ink on paper. Unlike conventional backlit flat panel displays that emit light, e-paper displays reflect light like paper, which can make them more comfortable to read, and provide a wider viewing angle than most light-emitting displays. An e-paper e-reader can provide better readability, especially in sunlight, and longer battery life, but lack the ability to present multimedia contents such as audio and/or video contents.

### SUMMARY

The present disclosure describes providing enriched e-reading experience in a multi-display environment (MDE).

In a first implementation, a computer-implemented method for providing an enriched e-reading experience in a multi-display environment (MDE), comprising: identifying, by a multi-display device that comprises at least an e-paper display and a multimedia display, an enriched e-book source, wherein the enriched e-book source comprises text for presenting by the e-paper display of the multi-display device and at least a keyword referring to at least a supplemental material for the text for presenting by the multimedia display of the multi-display device; presenting, by the e-paper display of the multi-display device, at least a first keyword, the first keyword referring to a first supplemental material for a first portion of the text for presenting by the multimedia display of the multi-display device; receiving, by the multi-display device, a user input that selects to present the first supplemental material for the first keyword by the multimedia display of the multi-display device; in response to receiving the user input, retrieving, by the multi-display device, the first supplemental material for the first keyword; and presenting, by the multimedia display of the multi-display device, the first supplemental material for the first keyword.

In a second implementation, a multi-display device that includes an e-paper display; a multimedia display; a non-transitory memory storage comprising instructions; and one or more processors in communication with the memory, wherein the one or more processors execute the instructions to: identify, by a multi-display device that comprises at least an e-paper display and a multimedia display, an enriched e-book source, wherein the enriched e-book source comprises text for presenting by the e-paper display of the multi-display device and at least a keyword referring to at least a supplemental material for the text for presenting by the multimedia display of the multi-display device; present, by the e-paper display of the multi-display device, at least a first keyword, the first keyword referring to a first supplemental material for a first portion of the text for presenting by the multimedia display of the multi-display device; receive, by the multi-display device, a user input that selects to present the first supplemental material for the first keyword by the multimedia display of the multi-display device; in response to receiving the user input, retrieve, by the multi-display device, the first supplemental material for the first keyword; and present, by the multimedia display of the multi-display device, the first supplemental material for the first keyword.

In a third implementation, a non-transitory computer-readable medium storing computer instructions for providing an enriched e-reading experience by a multi-display device that comprises at least an e-paper display and a multimedia display, that when executed by one or more processors, cause the one or more processors to perform the steps of: identifying, by the multi-display device, an enriched e-book source, wherein the enriched e-book source comprises text for presenting by the e-paper display of the multi-display device and at least a keyword referring to at least a supplemental material for the text for presenting by the multimedia display of the multi-display device; presenting, by the e-paper display of the multi-display device, at least a first keyword, the first keyword referring to a first supplemental material for a first portion of the text for presenting by the multimedia display of the multi-display device; receiving, by the multi-display device, a user input that selects to present the first supplemental material for the first keyword by the multimedia display of the multi-display device; in response to receiving the user input, retrieving, by the multi-display device, the first supplemental material for the first keyword; and presenting, by the multimedia display of the multi-display device, the first supplemental material for the first keyword.

The foregoing and other described implementations can each, optionally, include one or more of the following features.

A first feature, combinable with any of the following features, wherein the multimedia display comprises one or more of a Light-Emitting Diode (LED) display, a Liquid Crystal Display (LCD), an Organic Light-Emitting Diode Display (OLED), a colored e-paper display, or an audio output device.

A second feature, combinable with any of the previous or following features, wherein the first supplemental material for the first keyword comprises one or more of a picture, an audio, a video, a flash, a formula, or a second portion of the text.

A third feature, combinable with any of the previous or following features, wherein the first keyword comprises a Unique Resource Identifier (URI) referring to the first supplemental material for the first keyword for presenting by the multimedia display; and wherein retrieving the first supplemental material for the first keyword comprises retrieving the first supplemental material for the first keyword based on the URI referring to the first supplemental material for the first keyword.

A fourth feature, combinable with any of the previous or following features, wherein retrieving the first supplemental material for the first keyword comprises retrieving the first supplemental material for the first keyword locally from the multi-display device.

A fifth feature, combinable with any of the previous or following features, wherein the user input includes one or more of a touch, gesture, eye activity, or voice.

A sixth feature, combinable with any of the previous or following features, further including presenting, by the e-paper display of the multi-display device, a second keyword, the second keyword referring to a second supplemental material for a second portion of the text for presenting by the multimedia display of the multi-display device or by an output device external to the multi-display device; receiving, by the multi-display device, a second user input that selects to present the second supplemental material for the second keyword by the output device external to the multi-display device; and in response to receiving the second user input, instructing, by the multi-display device, the output device external to the multi-display device to present the second supplemental material for the second keyword.

A seventh feature, combinable with any of the previous or following features, wherein the multi-display device further includes user inference sensing components; wherein the user inference sensing components include one or more of a touchscreen, a camera, a gesture sensor, a motion sensor, an eye activity sensor, a microphone, a speaker, or an infra-red sensor; and wherein the user inference sensing components configured to receive the user input that selects to present the first supplemental material for the first keyword by the multimedia display of the multi-display device.

An eighth feature, combinable with any of the previous or following features, wherein the multi-display device further includes a second multimedia display, wherein the one or more processors execute the instructions to present the first keyword by presenting the first portion of the text and a first icon indicating that the first supplemental material for the first keyword is available for presenting by the second multimedia display of the multi-display device.

A ninth feature, combinable with any of the previous or following features, wherein the operations further include receiving, by the multi-display device, a second user input that selects to present the first supplemental material for the first keyword by the second multimedia display of the multi-display device; and in response to receiving the second user input, presenting, by the second multimedia display of the multi-display device, the first supplemental material for the first keyword.

A tenth feature, combinable with any of the previous or following features, wherein the operations further include presenting, by the e-paper display of the multi-display device, a second keyword, the second keyword referring to a second supplemental material for a second portion of the text for presenting by the multimedia display of the multi-display device or by an output device external to the multi-display device; receiving, by the multi-display device, a third user input that selects to present the second supplemental material for the second keyword by the output device external to the multi-display device; and in response to receiving the third user input, instructing, by the multi-display device, the output device external to the multi-display device to present the second supplemental material for the second keyword.

The previously described implementations are implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method and the instructions stored on the non-transitory, computer-readable medium.

The details of one or more implementations of the subject matter of this specification are set forth in the accompanying drawings and the description. Other features, aspects, and advantages of the subject matter will become apparent from the description, the drawings, and the claims.

### DESCRIPTION OF DRAWINGS

FIG. 1 is a schematic diagram illustrating an example multi-display environment (MDE), according to an implementation.

FIG. 2 is a schematic diagram illustrating a presentation of an example enriched e-book source by an e-paper display, according to an implementation.

FIG. 3 is a schematic diagram illustrating an example presentation of the keyword 212 and its corresponding icon 222 by the e-paper display 215 in FIG. 2, according to an implementation.

FIG. 4 is a schematic diagram illustrating an example presentation of multimedia contents by multimedia displays, according to an implementation.

FIG. 5 is a flowchart illustrating an example method for providing enriched e-reading experience in an MDE, according to an implementation.

FIG. 6 is a block diagram of an example computer system used to provide computational functionalities associated with described algorithms, methods, functions, processes, flows, and procedures, as described in the present disclosure, according to an implementation.

FIG. 7 is a schematic diagram illustrating an example structure of a data processing apparatus described in the present disclosure, according to an implementation.

FIG. 8 is a schematic diagram illustrating an example system for providing enriched e-reading experience in an MDE based on different types of use inputs, according to an implementation.

Like reference numbers and designations in the various drawings indicate like elements.

### DETAILED DESCRIPTION

The following detailed description describes providing enriched e-reading experience in a multi-display environment (MDE) and is presented to enable any person skilled in the art to make and use the disclosed subject matter in the context of one or more particular implementations.

Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail inasmuch as such details are within the skill of one of ordinary skill in the art. The present disclosure is not intended to be limited to the described or illustrated implementations, but to be accorded the widest scope consistent with the described principles and features.

A multi-display environment (MDE) refers to a system that includes two or more displays. The two or more displays can include the same or different output devices (including screens, audio/video players, or other output devices) for presenting information in one or more of visual, tactile, acoustic, or other forms. The two or more displays can be based on the same or different display technologies, including but not limited to, e-paper, Light-Emitting Diode (LED) display, Liquid Crystal Display (LCD), and Organic Light-Emitting Diode display (OLED) technologies.

In some implementations, an MDE can be implemented by a multi-display device (also referred to as an MDE device), such as a dual-screen smartphone or tablet device. In some implementations, the multi-display device can include two or more heterogeneous displays that include at least an e-paper display for presenting text and a multimedia display for presenting content in one or more of an audio, a video, or a combination of these and other formats different from the text. In some implementations, such content can be referred to as multimedia content (e.g., a sound clip, a video, an animation, a flash, and a color photo) that can be presented by the multimedia display in a format different from or in addition to the text format. For example, a multimedia display can include an LED display, an LCD, an OLED, a colored e-paper display, or another display screen that is coupled with or without an audio output device (e.g., a speaker). In some instances, a multimedia display can be implemented as a colored e-paper display capable to present text or even images in greyscale and color. In some instances, a multimedia display can be implemented as a phone cover that can provide an extended display to a cell phone. In some implementations, unlike a typical e-reader that has only one e-paper display in grayscale and does not have apps that may distract its user from reading, a multi-display device can enrich reading experience by leveraging the multimedia display, allowing more user interactions and providing a multimedia content to the users (readers).

In some implementations, when a user (or reader) comes across certain text on the e-paper display of the multi-display device, the multi-display device can project a content relevant to the text in a multimedia format, to one or more heterogeneous displays, such as an LCD or OLED screen, to make the e-reading experience more rich and interactive. For example, when reading from the e-paper display of the multi-display device, the multi-display device can display high resolution color pictures on an OLED screen when a user comes across a certain paint name on the e-paper screen, play a video on the LCD screen when a user comes across a certain movie name on the e-paper screen, display a formula on the LCD screen when a user comes across a certain math theory on the e-paper screen, play music using a speaker of the multi-display device when a user comes across a certain song name on the e-paper screen, or automatically display high resolution color picture on the LCD screen when there is black and white (BW) image on the e-paper screen. Additional or different operations can be performed by the multi-display device to enrich the user's e-reading experience.

In some implementations, rather than casting the same content from one device to another, the described techniques can cast or redirect an underlying content of the text or image presented on an e-paper display of the multi-display device to another display of the multi-display device. In some implementations, the described techniques can be implemented without requiring the multiple displays (or the devices in which the displays are included) to be connected to the same WiFi network. For example, the described techniques can retrieve multimedia files locally without network connection or retrieve multimedia files over the Internet, for example, through a cellular network.

In some implementations, the techniques described in this disclosure can achieve one or more advantages. For example, the described techniques can enhance e-reading experience to make e-reading more interesting and interactive. In some implementations, the described techniques can attract an audience to buy multimedia flavored e-books and introduce new revenue sources for authors and publishers. In some implementations, the described techniques can add value proposition and selling points for MDE devices, and bring in financial benefits to Original Equipment Manufacturers (OEMs) of the MDE devices. In some implementations, the described techniques can change or even revolutionize the e-reading experience without major e-paper screen hardware changes.

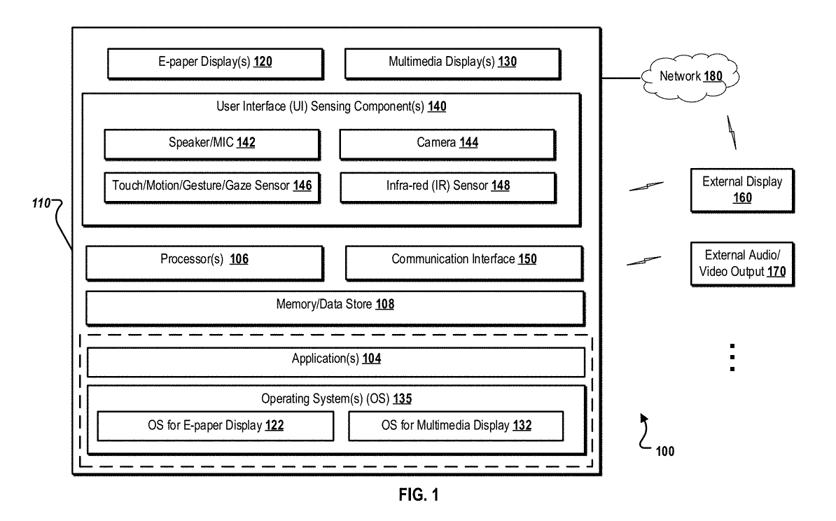

FIG. 1 is a schematic diagram illustrating an example multi-display environment 100, according to an implementation. The example multi-display environment 100 includes a multi-display device 110, an external display 160, an external audio/video output 170, and a network 180. The multi-display device 110 can be communicatively linked with the external display 160 and the external audio/video output 170, wirelessly (e.g., based on Bluetooth, WiFi, near field communication, or machine-to-machine communication technologies) or with wirelines (e.g., via one or more of a Universal Serial Bus (USB) or AV cable). The multi-display device 110 can be communicatively linked with the external display 160 and the external audio/video output 170 directly or through the network 180. The network 180 can be a wireless network, a wireline network, a hybrid, or combined communication network. The network 180 can be a telecommunication network based on existing or future-generation communication technologies, including but not limited to, Long Term Evolution (LTE), LTE-Advanced (LTE-A), 5G, Global System for Mobile communication (GSM), General Packet Radio Service (GPRS), Enhanced Data rates for GSM Evolution (EDGE), Interim Standard 95 (IS-95), Code Division Multiple Access (CDMA) 2000, Evolution-Data Optimized (EVDO), Universal Mobile Telecommunications System (UMTS), Wireless Local Access Network (WLAN), Digital Subscriber Line (DSL), fiber optic network, or the like. A multi-display environment can include additional or different devices, and can be configured in a different manner.

The multi-display device 110 includes one or more of an e-paper display 120, multimedia display 130, User Interference (UI) sensing component 140, processor 106, memory/data store 108, and antenna/communication interface 150. The multi-display device 110 may also have Operating System (OS) 135 and one or more applications 104 installed to perform the different operations of the multi-display device 110. The multi-display device 110 can include additional or different components, and can be configured in a different manner. For example, the multi-display device 110 can integrate multiple heterogeneous displays, such as one e-paper display 120 and two or more multimedia displays 130. In some implementations, the multi-display device 110 is implemented as a portable, mobile device, such as a dual- or multi-screen smartphone or tablet, which allows a user to enjoy the improved e-reading experience at the user's convenience.

In some implementations, the e-paper display 120 is configured to display or otherwise present text. For example, the e-paper display 120 can be an e-ink display based on the E-INK display technology. The multimedia display 130 is configured to display or otherwise present multimedia content (e.g., content in one or more of a color picture, audio, video, flash, or any other format, besides text). The multimedia display 130 can include one or more of an LED display, an LCD, an OLED, a colored e-paper display, or another display screen that is coupled with or without an audio output device (e.g., a speaker).

The Operating System (OS) 135 supports the multi-display device 110's basic functions, such as scheduling tasks, executing applications, and controlling peripherals. In some implementations, the OS 135 can be implemented as an integrated software module or a combination of different modules for different components of the multi-display device 110. For example, the OS 135 can include an OS 122 for the e-paper display 120 and an OS 132 for the multimedia display 130. In some implementations, the OS 122 for the e-paper display 120 can identify or discover other displays and output devices internal or external to the multi-display device 110, for projecting or redirecting multimedia contents to be presented by the one or more other displays and output devices. For example, a pairing or handshake procedure can be performed by the OS 122 for the e-paper display 120 and the OS 132 for the multimedia display 130 to establish communications for projecting or redirecting multimedia contents to be presented by the multimedia display 130. In some implementations, the OS 122 for the e-paper display 120 can register types of other displays or output devices for and perform necessary operations to ensure compatibility between the e-paper display 120 and other heterogeneous displays or output devices.

In some implementations, the UI sensing components 140 can include one or more of a speaker/microphone (MIC) 142, camera 144, touch/motion/gesture/eye activity sensor 146, infra-red (IR) sensor 148, or any other sensors that can detect and measure a user's interaction with the multi-display device 110. For example, the touch/motion/gesture/eye activity sensor 146 can include one or more of a touchscreen, camera, gesture sensor, motion sensor, or eye activity sensor. As a specific example, the touch/motion/gesture/eye activity sensor 146 can include a touchscreen for detecting a user's input by touching the screen with a stylus, figure, or hand. As a specific example, the touch/motion/gesture/eye activity sensor 146 can include an eye-tracking sensor that can detect and track locations (e.g., a position of a gaze) and movements of an eye relative to the head. The speaker/MIC 142 can include a MIC for detecting voice input and processing to recognize voice commands. In some implementations, the UI sensing components 140 are configured to receive user input that selects to present multimedia content corresponding by a multimedia display to improve a user's e-reading experience.

In some implementations, the one or more applications 104 running on the OS 135 provide the functionalities of improving a user's e-reading experience by using the multi-display device 110. For example, the one or more applications 104 can control the e-paper display 120 to present an enriched e-book source, receive and process a user's input (e.g., voice, gesture, eye activity, or touch) through the UI sensing components 140, and control the multimedia display 130 to present the multimedia contents based on the user's input. In some implementations, the one or more applications 104 receive the user's input through the one or more UI sensing components 140 and convert them into one or more instructions to instruct one or more of the e-paper display 120, the multimedia display 130, the external display 160, or the external audio/video output 170, for example, to present multimedia contents to improve the user's e-reading experience.

The memory/data store 108 can include non-transitory computer-readable media storing instructions executable by the one or more processors 106 to perform operations for improving the user's e-reading experience. In some implementations, the memory/data store 108 can store one or more enriched e-book sources that include text for presenting by the e-paper display 120 and multiple keywords referring to supplemental materials for the text (e.g., multimedia contents) for presenting by the multimedia display 130 of the multi-display device 110, the external display 160, or the external audio/video output 170.

In some implementations, the antenna/communication interface 150 is configured to allow the multi-display device 110 to establish cellular, WiFi, and other types of communications with the Internet, the external display 160, or the external audio/video output 170. In some implementations, the antenna/communication interface 150 is configured to retrieve multimedia contents for presenting by the multimedia display 130 of the multi-display device 110 from the Internet through the network 180.

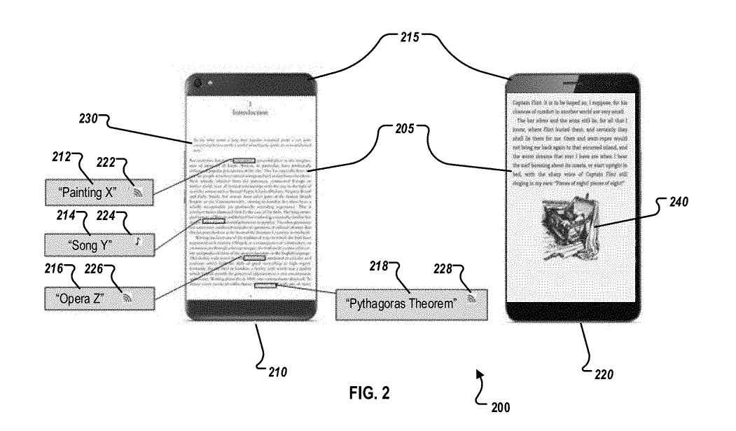

FIG. 2 is a schematic diagram illustrating a presentation 200 of an example enriched e-book source 205 by an e-paper display 215, according to an implementation. The e-paper display 215 can be the example e-paper display 120 of the multi-display device 110 in FIG. 1 or another e-paper display of another multi-display device. The presentation 200 of the example enriched e-book source 205 includes a first presentation of a first page 210 and a second presentation of a second page 220 of the example enriched e-book source 205.

As illustrated, the example enriched e-book source 205 includes text 230 and a BW image 240, both of which are presented by the e-paper display 215 in grayscale. Here, the enriched e-book source 205 is the ordinary e-book or electronic article presented to the readers for general reading. The text 230 is the text portion in the e-book source. The text 230 can include all the words, phrases, terms, paragraphs, etc. that are included in the enriched e-book source 205.

The example enriched e-book source 205 further includes a number of keywords that are displayed by the e-paper display 215. The keywords can be associated with, linked to, or otherwise refer to supplemental materials for the text 230 for presenting by a multimedia display. In some implementations, a keyword may include one or more terms or phrases that are a portion of the text (e.g., a portion of the text 230). For example, the keywords can include names of persons, drawings, music, videos, movies, scientific theories, or any other terms or phrases. As illustrated in FIG. 2, a keyword “Painting X” 212 include an underlying textual term “Painting X” that is a portion of the text 230.

The keywords refer to supplemental materials (e.g., multimedia contents) for the terms or phrases that can be presented in a multimedia form to facilitate a reader's appreciation and/or understanding. The supplemental materials can include multimedia contents (e.g., a color picture, audio, video, formula, or flash) corresponding to the terms or phrases that are available for presenting by a multimedia display. For example, the first presentation of a first page 210 shows example keywords “Painting X” 212, “Song Y” 214, “Opera Z” 216, and “Pythagoras Theorem” 218. In some implementations, the keywords may include terms of art or well-known terms or phrases. For example, the Painting X can be the painting of Mona Lisa; the Song Y can be the song of O Sole Mio; and the Opera Z can be the opera of Carmen. Accordingly, the supplemental material referred to by the keyword “Painting X” 212 can include a color image of the painting of Mona Lisa; the supplemental material referred to by the keyword “Song Y” 214 can include an audio of the song of O Sole Mio; the supplemental material referred to by the keyword “Opera Z” 216 can include a video of the opera of Carmen; and the supplemental material referred to by the keyword “Pythagoras Theorem” 218 can include a mathematical formula or even a tutorial of the Pythagoras Theorem. In some implementations, a BW image 240 itself can serve as a keyword to indicate that a high-resolution color version can be presented by a multimedia display. For example, the second presentation of the second page 220 shows the BW image 240 as another example keyword.

In some implementations, a keyword can include one or more icons (e.g., tags, flags, annotations, or other indications) related to or associated with the one or more terms or phrases. The one or more icons can annotate, highlight, or otherwise flag the keywords to the reader's attention that there are supplemental materials for the terms or phrases available for presenting by a multimedia display. As illustrated in FIG. 2, the keyword “Painting X” 212 includes an icon 222. In some implementations, as an alternative to or in addition to displaying one or more icons, the e-paper display 215 can present the keywords in a different font, color, style, highlight, or in another manner to distinguish non-keyword text to indicate that there are supplemental materials for the underlying terms or phrases for presenting by a multimedia display.

A keyword can be associated with one or more respective icons. In some implementations, an icon can be displayed, by the e-paper display, approximate to, on top of, partially or fully overlapping with, offset from, or otherwise in association with the underlying term or phrase of the corresponding keyword. For example, as shown in FIG. 2, each of the keywords “Painting X” 212, “Song Y” 214, “Opera Z” 216, and “Pythagoras Theorem” 218 has a respective icon 222, 224, 226, or 228 displayed next to its corresponding terms. In some implementations, the icons are the same for all keywords. In some implementations, the icons are different for different keywords (e.g., based on the types of multimedia contents to which the keywords refer to). In some implementations, the icons can indicate one or more options of presenting the supplemental materials by the multimedia display.

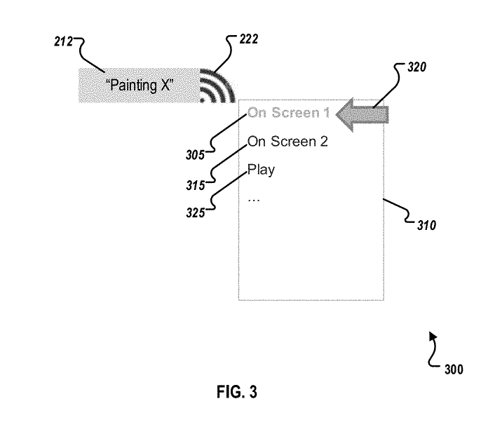

FIG. 3 is a schematic diagram illustrating an example presentation 300 of the keyword 212 and its corresponding icon 222 by the e-paper display 215 in FIG. 2, according to an implementation. The example presentation 300 can be presented by the e-paper display 215 in response to a user interaction with the keyword 212 (e.g., a single-click of the icon 222 or a long press of the phrase “Painting X”) or other user interactions with the e-paper display 215 or any other UI sensing components of a multi-display device.

The example presentation 300 includes a drop-down window 310 that shows example options 305, 315, and 325 of presenting the multimedia content of the keyword 212 by one or more multimedia displays. For example, option 305 refers to presenting the multimedia content of the keyword 212 by Screen 1; option 315 refers to presenting the multimedia content of the keyword 212 by Screen 2; option 325 refers to playing audio/video content associated with the keyword 212 by an audio/video output device. The drop-down window 310 can be displayed, for example, in response to the user's interaction with the keyword 212 (e.g., a single-click of the icon 222, a long press of the phrase “Painting X,” a voice command of “Show Painting X,” a slide or other gesture over the e-paper display 215 that interacts with the keyword 212, etc.). As illustrated in FIG. 3, the user selects option 305 to project the “Painting X” picture on “Screen 1,” as shown by the arrow 320. Additional or different options can be included.

In some implementations, Screen 1 can be a default heterogeneous screen with respect to the e-paper screen 215. For example, Screen 1 can be one of the multimedia displays integrated in the same multi-display device that includes the e-paper screen 215. In some implementations, Screen 2 can be an output device external to the same multi-display device that includes the e-paper screen 215. Additional or different options of presenting the multimedia contents by the multimedia display can be configured. For example, upon a defined user interaction (e.g., a double-click) with the BW image 240, the high resolution color pictures corresponding to the BW image 240 can be automatically displayed on a default heterogeneous screen, say, Screen 1.

In some implementations, the presentation 300 of the keyword 212 and its corresponding icon 222 can be presented by the e-paper display 215 in another manner, for example, using a conversational pop-up window, using other types of visualizations to indicate options of presenting the multimedia contents by the multimedia display. In some implementations, additional or different user inputs (e.g., voice or gesture control) can be used to select the options of presenting the multimedia contents by the multimedia display.

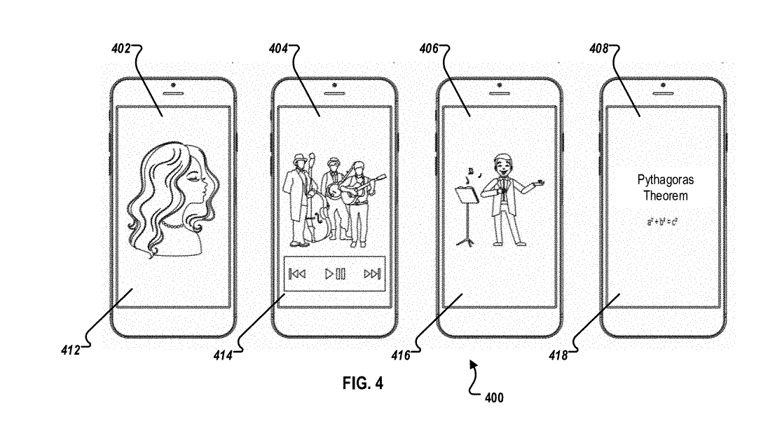

FIG. 4 is a schematic diagram illustrating example presentation 400 of multimedia contents by multimedia displays 402, 404, 406, and 408, according to an implementation. The example presentation 400 includes respective presentations of a high-resolution color picture of “Painting X” 412 corresponding to the keyword “Painting X” 212 by a multimedia display 402; playing the song of “Song Y” 414 corresponding to the keyword “Song Y” 214 by a multimedia display 404; playing a video of “Opera Z” 416 corresponding to the keyword “Opera Z” 216 by a multimedia display 406; and displaying the formula of “Pythagoras Theorem” 418 corresponding to the keyword 218 by a multimedia display 408.

The multimedia displays 402, 404, 406, and 408 can be one or more of the example multimedia displays 130 of the multi-display device 110, the external display 160, the external audio/video output 170 in FIG. 1, or another output device.

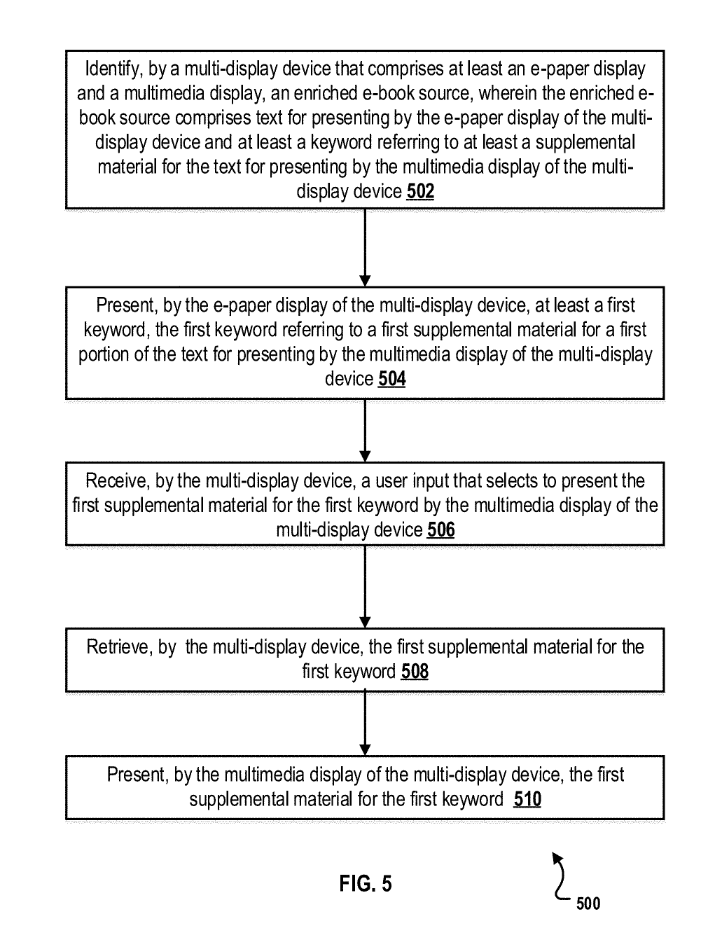

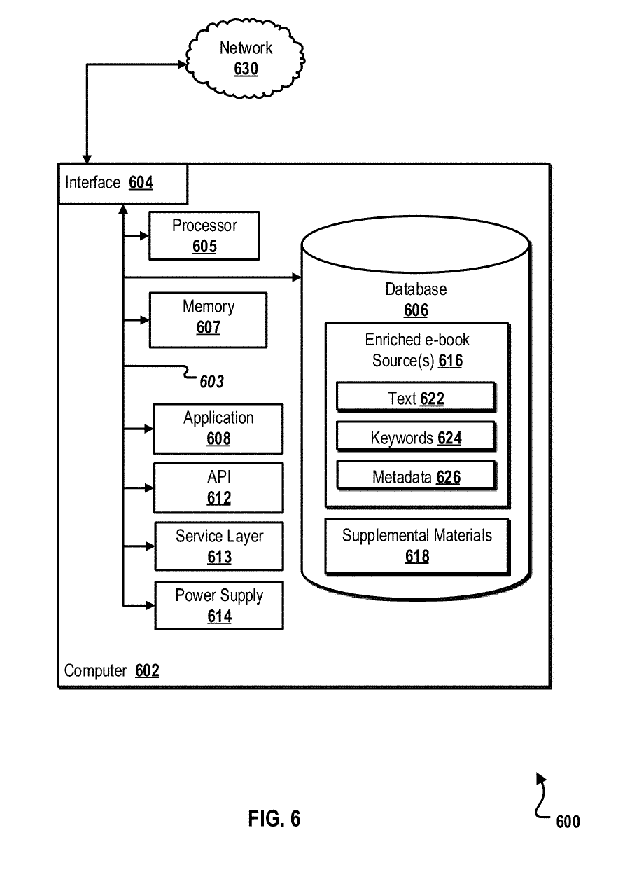

FIG. 5 is a flowchart illustrating an example method 500 for providing enriched e-reading experience in a multi-display environment (MDE), according to an implementation. The method 500 can be implemented by a multi-display device that includes at least an e-paper display and a multimedia display. The multimedia display can include one or more of an LED display, an LCD, an OLED, an e-paper display, a colored e-paper display, or an audio output device. In some implementations, the multi-display device further includes user inference sensing components. The user inference sensing components include one or more of a touchscreen, a camera, a gesture sensor, a motion sensor, an eye activity sensor, a microphone, a speaker, or an infra-red sensor. In some implementations, either or both of the e-paper display and the multimedia display include a touch screen. In some implementations, the multi-display device can include a first operating system that is associated with the e-paper display; and a second operating system that is associated with the multimedia display. The first operating system can be the same or different from the second operating system. In some implementations, the multi-display device can be the multi-display device 110, the example computer system 600 shown in FIG. 6, or another device.

The method 500 can also be implemented using additional, fewer, or different entities. Furthermore, the method 500 can also be implemented using additional, fewer, or different operations, which can be performed in the order shown or in a different order. In some instances, an operation or a group of operations can be iterated or repeated, for example, for a specified number of iterations or until a terminating condition is reached.

The example method 500 begins at 502, where a multi-display device identifies an enriched e-book source. The enriched e-book source can include text for presenting by the e-paper display of the multi-display device and at least a keyword (e.g., keywords 212, 214, 216, and 218 in FIG. 2) referring to at least a supplemental material for the text for presenting by the multimedia display of the multi-display device. The supplemental materials for the text can include multimedia contents (e.g., the multimedia contents 412, 414, 416, and 418 in FIG. 4) that can be presented in one or more of a picture, an audio, a video, a flash, a formula, or a combination of these and other media formats.

In some implementations, the enriched e-book source can include the text and the keywords by including data that is displayed or presented as the text and the keywords (e.g., in a similar or different manner as shown in FIG. 2). In some implementations, the enriched e-book source can be in one or more formats, including, but not limited to, ePUB, PDF, TXT, AZW, AZW3, KF8, non-DRM MOBI, PRC, TXT EPUB, PDF EPUB, IBA (Multi-touch books made via iBooks Author), TXT, RTF, DOC, BBeB EPUB, HTML, CBR (comic), CBZ (comic) EPUB DRM, EPUB, PDF DRM, PDF, FB2, FB2.ZIP, DJVU, HTM, HTML, DOC, DOCX, RTF, CHM, TCR, and PRC (MOBI).

In some implementations, identifying the enriched e-book source includes retrieving the enriched e-book source from a memory, database, or another data storage device of the multi-display device. In some implementations, identifying the enriched e-book source includes receiving the enriched e-book source, for example, by accessing, downloading, or otherwise receiving the enriched e-book source from the cloud, a publisher of the enriched e-book source, or other external devices via a communication interface of the multi-display device.

In some implementations, the enriched e-book source can be generated based on a regular e-book source that includes text for presenting by an e-paper display without supplemental materials. For example, the enriched e-book source can be generated by one or more of an e-book author, an e-book publisher, a device manufacturer, or a third party. In some implementations, keywords refer to supplemental materials that can help readers better understand the underlying text or otherwise improve or enrich the reading experience. The supplemental materials can be procured or otherwise obtained or made available to the reader. For example, the supplemental materials can be procured by one or more of an e-book author, an e-book publisher, a device manufacturer, or a third party from the supplemental material publisher or provider.

The supplemental materials can be associated with, linked to or otherwise referred by the corresponding keywords. For example, the supplemental materials can be linked to the corresponding keywords via maps, pointers, or other data structures. As an example, a keyword can include a Unique Resource Identifier (URI) referring to a supplemental material available for presenting by the multimedia display. In some implementations, linking the corresponding keywords with the supplemental materials using URIs can reduce the size of the enriched e-book source and allow real time updates of the supplemental materials. The URIs can link the corresponding keywords with the supplemental materials that are stored locally at the multi-display device or stored remotely over the Internet.

In some implementations, a keyword includes one or more icons (e.g., icons 222, 224, 226, and 228 in FIGS. 2 and 3). The icons can be displayed on the e-paper display to indicate to a reader that there are supplemental materials available for presenting by a multimedia display or other output devices.

In some implementations, the enriched e-book source can include metadata that includes URI fields, icons, and any other information for providing mapping information of the keywords, the icons, and the respective supplemental materials for addressing, retrieving, and presenting the respective supplemental materials.

In some implementations, the supplemental materials can be directly embedded in the enriched e-book source. In some implementations, the supplemental materials can be accessed or downloaded via a communication network, for example, after the enriched e-book source is first loaded in the multi-display device, or after one or more supplemental materials are requested by a user of the multi-display device upon selecting corresponding keywords in real time or substantially real time.

At 504, the e-paper display of the multi-display device displays or otherwise presents at least a first keyword. The first keyword (e.g., the keyword “Painting X” 212) refers to a first supplemental material (e.g., a high-resolution color picture of Painting X 412) for a first portion of the text (e.g., the term “Painting X”) for presenting by the multimedia display (e.g., the multimedia display 402) of the multi-display device. In some implementations, the first supplemental material for the first keyword comprises one or more of a picture, an audio, a video, a flash, a formula, or a second portion of the text.

In some implementations, presenting the first keyword includes presenting the first portion of the text and a first icon (e.g., icons 222 in FIGS. 2 and 3) indicating that the first supplemental material for the first keyword is available for presenting by the multimedia display of the multi-display device. In some implementations, the first icon can be presented by the e-paper display, approximate to, on top of, partially or fully overlapping with, offset from, or otherwise in association with the first portion of the text to annotate, highlight, or otherwise show that there are corresponding supplemental materials for the first portion of the text for presenting by the multimedia display of the multi-display device. In some implementations, the first icon can be presented by the e-paper display at the same or a later time with the first portion of the text. For example, the first icon can be presented by the e-paper display in response to a user interaction (e.g., a touch of the e-paper display, a voice control, or a gesture control) with the first portion of the text. In some implementations, the first icon can further indicate one or more options of presenting the first supplemental material by the multimedia display of the multi-display device, for example, as shown in FIG. 3 or in a different manner. In some implementations, additional or different options can be configured and displayed in the first icon. For example, an option can be configured to email or text the first supplemental material for later viewing so can the user can continue to read uninterrupted, but can also obtain the first supplemental material for later reading.

In some implementations, the first icon can include one or more of a drop-down menu, a pop-up window, an audio instruction, or other notifications that allows a reader to select the one or more options of presenting the first supplemental material by one or more heterogeneous screens. The heterogeneous screens include, for example, the multimedia display of the multi-display device, and one or more output devices external to the multi-display device. In some implementations, the one or more of a drop-down menu, a pop-up window, an audio instruction, or other notifications can be presented by the e-paper display in response to the reader's interaction (e.g., a touch of the e-paper display, a voice control, or a gesture control) with the first portion of the text, for example, by a touch on a touch screen, a voice control command through a microphone, or a motion or gesture detected by a camera or sensor of the multi-display device.

At 506, the multi-display device receives a user input that selects to present the first supplemental material for the first keyword by the multimedia display of the multi-display device. The multi-display device can process the user input and identify a target heterogeneous screen requested by the reader for displaying the first supplemental material. The user input can include one or more of a touch (including one or more of a click, a tap, a press, or a combination of these and other user interactions with a touch screen), gesture, eye activity, voice, or other inputs.

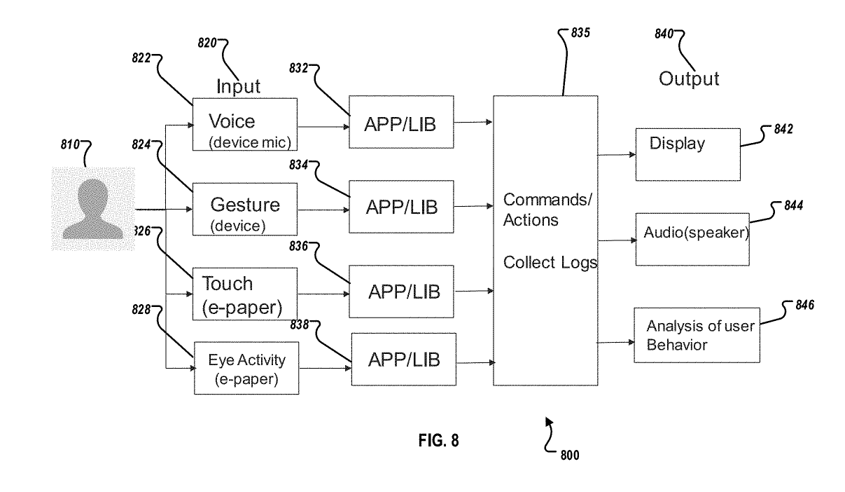

FIG. 8 is a schematic diagram illustrating an example multi-display device 800 for providing enriched e-reading experience in an MDE based on different types of use inputs, according to an implementation. The example multi-display device 800 can receive and process one or more types of inputs 820 of a user 810, and return outputs 840 such as supplemental materials for presenting by a multimedia display that includes one or more displays 842 and an audio output device (e.g., a speaker) 844, or for analysis of user behavior 846 (e.g., for use in advertising). In some implementations, the one or more displays 842 can also include a display external to the multi-display device (e.g., an external TV linked to the multi-display device by WiFi).

For example, the multi-display device can detect the user input by detecting a touch 826 on a touch screen (of the e-paper display of the multi-display device), a voice 822 through a microphone of the multi-display device, a gesture 824 by a camera or sensor of the multi-display device, and an eye activity 828 by a camera or an eye activity sensor (of the e-paper display of the multi-display device. As an example, instead of touching the first keyword (e.g., “Painting X”) on the e-paper screen, the user 810 can say “e-display, show ‘Painting X.’” Then, the multi-display device will display the Painting X on a default multimedia display of the multi-display device. As another example, the user 810 can make a predefined gesture 824 (including one or more movements of a hand, an arm, or other parts of the body of the user 810) or an eye activity 828 (include, for example, a gaze or motion of an eye relative to the head) to select option 305 to project the “Painting X” picture on “Screen 1” as shown in FIG. 3. The camera or sensor of the multi-display device can detect the gesture 824 and the eye activity 828, and the multi-display device can then display the “Painting X” on Screen 1 of the multi-display device.

The example multi-display device 800 can perform pattern recognition or other algorithms to process the different types of user inputs 820 detected by corresponding UI sensing components (e.g., mic, camera, sensor, or touch screen) of the multi-display device to achieve voice, gesture, eye activity, and touch recognition. For example, the example multi-display device 800 can use respective applications/libraries (APP/LIBs) 832, 834, 836, and 838 to process the voice 822, gesture 824, touch 826, and eye activity 828. With the respective APP/LIBs 832, 834, 836, and 838, the example multi-display device 800 can execute voice, gesture, touch, eye activity, recognition algorithms to generate one or more commands/actions or collect logs 835 corresponding to the user input of the voice 822, gesture 824, touch 826, and eye activity 828, respectively. The commands/actions or logs 835 can instruct the multimedia display (e.g., the display 842 and the audio output device 844) to present a supplemental material of a keyword based on a recognized user input of the voice 822, gesture/eye activity 824, touch 826, and eye activity 828, respectively.

Referring back to FIG. 5, at 508, in response to receiving the user input, the multi-display device retrieves the first supplemental material for the first keyword. In some implementations, retrieving the first supplemental material for the first keyword includes retrieving the first supplemental material for the first keyword based on a URI referring to the first supplemental material for the first keyword remotely over a communication network or retrieving the first supplemental material for the first keyword locally from the multi-display device.

For example, retrieving the first supplemental material for the first keyword locally from the multi-display device can include retrieving the retrieving the first supplemental material for the first keyword that is embedded in the enriched e-book source or in another file from a memory, database, or another data storage device of the multi-display device.

In some implementations, retrieving the first supplemental material for the first keyword includes retrieving the first supplemental material for the first keyword from a corresponding multimedia content provider (e.g., a digital content publisher or a search engine capable of searching and locating the first supplemental material for the first keyword) or the cloud over a communication network (e.g., the Internet). For example, retrieving the first supplemental material for the first keyword includes retrieving the first supplemental material for the first keyword based on a URI referring to the first supplemental material for the first keyword. In some implementations, the multi-display device can retrieve the first supplemental material for the first keyword by accessing the metadata of the enriched e-book source, locating the first supplemental material for the first keyword based on the corresponding URLs (or maps, pointers, or other data structures), and accessing, downloading, or otherwise receiving the first supplemental material for the first keyword.

In some implementations, after the multi-display device identifies the enriched e-book source at 502, the multi-display device can make the supplemental materials available to the multimedia display of the multi-display device (e.g., by sharing the supplemental material, the metadata, or both with the multimedia display of the multi-display device) to make the re-direction of the presentation of the supplemental materials by the multimedia display of the multi-display device easier and faster.

At 510, the multimedia display of the multi-display device presents the first supplemental material for the first keyword. In some implementations, the multimedia display of the multi-display device presents the first supplemental material for the first keyword in a similar or different manner as the presentation 400 shown in FIG. 4. In some implementations, the multimedia display of the multi-display device can enable auto-adaptation, automatic UI tracking (e.g., tracking the progress in book reading), or any other features based on the first supplemental material for the first keyword to further improve user experience. In some implementations, the multi-display device can allow different display configurations (e.g., to rotate, duplicate, extend, split, or otherwise use one or more of the e-paper displays, the multimedia display of the multi-display, or the external output devices). As an example, the multi-display device can include two or more multimedia displays and the first supplemental material for the first keyword are presented, for example, simultaneously or collaboratively, by the two or more multimedia displays of the multi-display device. In some implementations, the multimedia display of the multi-display device can achieve additional features such as power saving and eye protection in presenting the first supplemental material for the first keyword.

In some implementations, the multi-display device can include a second multimedia display. In some implementations, the e-paper display can present the first portion of the text (e.g., the underlying term or phrase included in the first keyword) and a first icon indicating that the first supplemental material for the first keyword is available for presenting by the second multimedia display of the multi-display device (e.g., as an option of presenting the first supplemental material for the first keyword). For example, the e-paper display can present the first portion of the text (e.g., the term “Painting X” of the keyword 212) and a first icon (e.g., the icon 222) indicating that the first supplemental material for the first keyword is available for presenting by the second multimedia display of the multi-display device In some implementations, the multi-display device can receive a second user input that selects to present the first supplemental material for the first keyword by the second multimedia display of the multi-display device. In response to receiving the second user input, the second multimedia display of the multi-display device presents the first supplemental material for the first keyword.

In some implementations, the e-paper display of the multi-display device can present a second keyword. The second keyword refers to a second supplemental material for a second portion of the text (e.g., the underlying term or phrase included in the second keyword such as the term “Song Y” of the keyword 214) for presenting by the multimedia display of the multi-display device or by an output device external to the multi-display device (e.g., the external display 160, the external audio/video output 170, or some other devices). In some instances, the second portion of the text is different from the first portion of the text, although the underlying textual term or phrase can be the same. For example, the second keyword can have the same underlying term “Painting X” as the first keyword 212, but the second keyword appears in a different location (a different sentence, paragraph, or page) of the text. In some implementations, the multi-display device receives a third user input that selects to present the second supplemental material for the second keyword by the output device external to the multi-display device. In response to receiving the third user input, the multi-display device can instruct the output device external to the multi-display device to present the second supplemental material for the second keyword. For example, the multi-display device can establish communications with the output device external to the multi-display device. In some implementations, the multi-display device and the output device external to the multi-display device can perform a pairing or handshake procedure to establish initial communication to ensure compatibility. For example, the multi-display device can register the type of the output device external to the multi-display device (e.g., by identifying whether it is an e-link display, a multi-media display, a printer, or another type of output device). The multi-display device can perform necessary processing, such as, formatting control information or signaling instructions, or reformatting the second supplemental material for the second keyword for communication with the output device external to the multi-display device.

In some implementations, instructing the output device external to the multi-display device to present the second supplemental material for the second keyword can include making the second supplemental material for the second keyword available to the output device external to the multi-display device, for example, by transmitting the second supplemental material itself or transmitting the metadata (e.g., the URL address) of the second multimedia content to the output device external to the multi-display device.

In some implementations, after the multi-display device identifies the enriched e-book source at 502, the multi-display device can make the supplemental materials available to the output device external to the multi-display device after the pairing or handshake procedure. For example, the multi-display device can make the supplemental materials available to the output device external to the multi-display device by sharing the supplemental materials, the metadata, or both with the multimedia display of the multi-display device, to make the re-direction of the presentation of the supplemental materials by the output device external to the multi-display device easier and faster. In some implementations, the supplemental materials are maintained by the multi-display device, and only the metadata is transmitted to the output device external to the multi-display device, for example, for improved security and communication efficiency.

FIG. 6 is a block diagram of an example computer system 600 used to provide computational functionalities associated with described algorithms, methods, functions, processes, flows, and procedures, as described in the instant disclosure, according to an implementation. The computer system 600, or more than one computer system 600, can be used to implement the example methods described previously in this disclosure.

The illustrated computer 602 is intended to encompass any computing device, such as a server, desktop computer, laptop/note-book computer, wireless data port, smart phone, Personal Data Assistant (PDA), tablet computing device, one or more processors within these devices, or any other suitable processing device, including physical or virtual instances (or both) of the computing device. Additionally, the computer 602 may include a computer that includes an input device, such as a keypad, keyboard, touch screen, or other device that can accept user information, and an output device that conveys information associated with the operation of the computer 602, including digital data, visual, or audio information (or a combination of information), or a graphical user interface (GUI).

The computer 602 can serve in a role as a client, network component, a server, a database or other persistency, or any other component (or a combination of roles) of a computer system for performing the subject matter described in the instant disclosure. The illustrated computer 602 is communicably coupled with a network 630. In some implementations, one or more components of the computer 602 may be configured to operate within environments, including cloud-computing-based, local, global, or other environment (or a combination of environments).

At a high level, the computer 602 is an electronic computing device operable to receive, transmit, process, store, or manage data and information associated with the described subject matter. According to some implementations, the computer 602 may also include or be communicably coupled with an application server, e-mail server, web server, caching server, streaming data server, or other server (or a combination of servers).

The computer 602 can receive requests over network 630 from a client application (for example, executing on another computer 602) and respond to the received requests by processing the received requests using an appropriate software application(s). In addition, requests may also be sent to the computer 602 from internal users (for example, from a command console or by other appropriate access methods), external or third-parties, other automated applications, as well as any other appropriate entities, individuals, systems, or computers.

Each of the components of the computer 602 can communicate using a system bus 603. In some implementations, any or all of the components of the computer 602, hardware or software (or a combination of both hardware and software), may interface with each other or the interface 604 (or a combination of both), over the system bus 603 using an Application Programming Interface (API) 612 or a service layer 613 (or a combination of the API 612 and service layer 613). The API 612 may include specifications for routines, data structures, and object classes. The API 612 may be either computer-language independent or dependent and refer to a complete interface, a single function, or even a set of APIs. The service layer 613 provides software services to the computer 602 or other components (whether or not illustrated) that are communicably coupled to the computer 602. The functionality of the computer 602 may be accessible for all service consumers using this service layer. Software services, such as those provided by the service layer 613, provide reusable, defined functionalities through a defined interface. For example, the interface may be software written in JAVA, C++, or other suitable languages providing data in an extensible markup language (XML) format or other suitable formats. While illustrated as an integrated component of the computer 602, alternative implementations may illustrate the API 612 or the service layer 613 as stand-alone components in relation to other components of the computer 602 or other components (whether or not illustrated) that are communicably coupled to the computer 602. Moreover, any or all parts of the API 612 or the service layer 613 may be implemented as child or sub-modules of another software module, enterprise application, or hardware module without departing from the scope of this disclosure.

The computer 602 includes an interface 604. Although illustrated as a single interface 604 in FIG. 6, two or more interfaces 604 may be used according to particular needs, desires, or particular implementations of the computer 602. The interface 604 is used by the computer 602 for communicating with other systems that are connected to the network 630 (whether illustrated or not) in a distributed environment. Generally, the interface 604 includes logic encoded in software or hardware (or a combination of software and hardware) and is operable to communicate with the network 630. More specifically, the interface 604 may include software supporting one or more communication protocols associated with communications such that the network 630 or interface's hardware is operable to communicate physical signals within and outside of the illustrated computer 602.

The computer 602 includes a processor 605. Although illustrated as a single processor 605 in FIG. 6, two or more processors may be used according to particular needs, desires, or particular implementations of the computer 602. Generally, the processor 605 executes instructions and manipulates data to perform the operations of the computer 602 and any algorithms, methods, functions, processes, flows, and procedures as described in the instant disclosure. For example, the processor 605 is in communication with non-transitory memory storage (e.g., memory 607 and database 606) and executes instructions and manipulates data to perform some or all operations described with respect to FIG. 5.

The computer 602 also includes a database 606 that can hold data for the computer 602 or other components (or a combination of both) that can be connected to the network 630 (whether illustrated or not). For example, database 606 can be an in-memory, conventional, or other type of database storing data consistent with this disclosure. In some implementations, database 606 can be a combination of two or more different database types (for example, a hybrid in-memory and conventional database) according to particular needs, desires, or particular implementations of the computer 602 and the described functionality. Although illustrated as a single database 606 in FIG. 6, two or more databases (of the same or combination of types) can be used according to particular needs, desires, or particular implementations of the computer 602 and the described functionality. While database 606 is illustrated as an integral component of the computer 602, in alternative implementations, database 606 can be external to the computer 602.

In some implementations, the database 606 can store one or more enriched e-book sources 616. In some implementations, the enriched e-book sources 616 include text 622 for presenting by an e-paper display, a number of keywords 624 referring to multimedia contents available for presenting by a multimedia display, and metadata 626 that can include information mapping the keywords and the respective multimedia contents, and a number of icons corresponding to the number of keywords. In some implementations, the database 606 can store some or all supplemental materials 618 referred to in the enriched e-book sources 616 locally for presenting by a multimedia display. In some implementations, some or all supplemental materials 618 referred to in the enriched e-book sources 616 can be obtained via the network 630.

The computer 602 also includes a memory 607 that can hold data for the computer 602 or other components (or a combination of both) that can be connected to the network 630 (whether illustrated or not). For example, memory 607 can be random access memory (RAM), read-only memory (ROM), optical, magnetic, and the like, storing data consistent with this disclosure. In some implementations, memory 607 can be a combination of two or more different types of memory (for example, a combination of RAM and magnetic storage) according to particular needs, desires, or particular implementations of the computer 602 and the described functionality. Although illustrated as a single memory 607 in FIG. 6, two or more memories 607 (of the same or combination of types) can be used according to particular needs, desires, or particular implementations of the computer 602 and the described functionality. While memory 607 is illustrated as an integral component of the computer 602, in alternative implementations, memory 607 can be external to the computer 602.

The application 608 is an algorithmic software engine providing functionality according to particular needs, desires, or particular implementations of the computer 602, particularly with respect to functionality described in this disclosure. For example, application 608 can serve as one or more components, modules, or applications. Further, although illustrated as a single application 608, the application 608 may be implemented as multiple applications 608 on the computer 602. In addition, although illustrated as integral to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion or management circuits (including recharging, standby, or other power management functionality). In some implementations, the power supply 614 can include a power plug to allow the computer 602 to be plugged into a wall socket or other power source to, for example, power the computer 602 or recharge a rechargeable battery.

There may be any number of computers 602 associated with, or external to, a computer system containing computer 602, each computer 602 communicating over network 630. Further, the term “client,” “user,” and other appropriate terminology may be used interchangeably, as appropriate, without departing from the scope of this disclosure. Moreover, this disclosure contemplates that many users may use one computer 602, or that one user may use multiple computers 602.

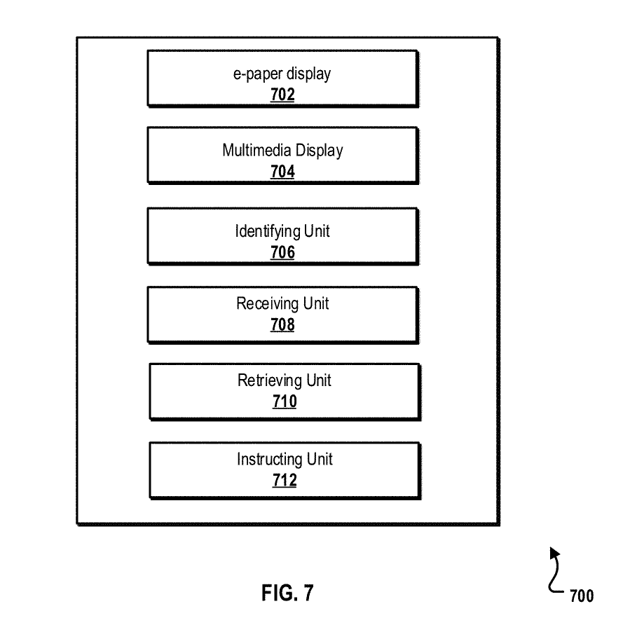

FIG. 7 is a schematic diagram illustrating an example structure of a data processing apparatus 700 described in the present disclosure, according to an implementation. The data processing apparatus 700 can be used to improve e-reading experience in a multi-display environment (MDE). The data processing apparatus 700 includes an e-paper display 702, a multimedia display 704, an identifying unit 706, a receiving unit 708, a retrieving unit 710, and an instructing unit 712.

The identifying unit 706 is configured to identify an enriched e-book source. The enriched e-book source includes text for presenting by the e-paper display of the multi-display device and a number of keywords referring to supplemental materials for the text for presenting by the multimedia display of the multi-display device.

The e-paper display 702 is configured to present at least a first keyword of the number of keywords. The first keyword refers to a first supplemental material for a first portion of the text for presenting by the multimedia display of the multi-display device.

The receiving unit 708 is configured to receive a user input that selects to present the first supplemental material for the first keyword by the multimedia display of the multi-display device, a second multimedia display of the multi-display device, or an output device external to the multi-display device.

The retrieving unit 710 is configured to, in response to receiving the user input, retrieve the first supplemental material for the first keyword. In some implementations, the retrieving unit 710 is configured to retrieve the first supplemental material for the first keyword based on a URI referring to the first supplemental material for the first keyword remotely over a communication network or retrieving the first supplemental material for the first keyword locally from the multi-display device.

The multimedia display 704 is configured to present the first supplemental material for the first keyword.

The instructing unit 712 is configured to instruct an output device external to the multi-display device to present the second supplemental material for a second keyword.

Described implementations of the subject matter can include one or more features, alone or in combination.

For example, in a first implementation, a computer-implemented method for providing an enriched e-reading experience in a multi-display environment (MDE), comprising: identifying, by a multi-display device that comprises at least an e-paper display and a multimedia display, an enriched e-book source, wherein the enriched e-book source comprises text for presenting by the e-paper display of the multi-display device and at least a keyword referring to at least a supplemental material for the text for presenting by the multimedia display of the multi-display device; presenting, by the e-paper display of the multi-display device, at least a first keyword, the first keyword referring to a first supplemental material for a first portion of the text for presenting by the multimedia display of the multi-display device; receiving, by the multi-display device, a user input that selects to present the first supplemental material for the first keyword by the multimedia display of the multi-display device; in response to receiving the user input, retrieving, by the multi-display device, the first supplemental material for the first keyword; and presenting, by the multimedia display of the multi-display device, the first supplemental material for the first keyword.

In a second implementation, a multi-display device that includes an e-paper display; a multimedia display; a non-transitory memory storage comprising instructions; and one or more processors in communication with the memory, wherein the one or more processors execute the instructions to: identify, by a multi-display device that comprises at least an e-paper display and a multimedia display, an enriched e-book source, wherein the enriched e-book source comprises text for presenting by the e-paper display of the multi-display device and at least a keyword referring to at least a supplemental material for the text for presenting by the multimedia display of the multi-display device; present, by the e-paper display of the multi-display device, at least a first keyword, the first keyword referring to a first supplemental material for a first portion of the text for presenting by the multimedia display of the multi-display device; receive, by the multi-display device, a user input that selects to present the first supplemental material for the first keyword by the multimedia display of the multi-display device; in response to receiving the user input, retrieve, by the multi-display device, the first supplemental material for the first keyword; and present, by the multimedia display of the multi-display device, the first supplemental material for the first keyword.

In a third implementation, a non-transitory computer-readable medium storing computer instructions for providing an enriched e-reading experience by a multi-display device that comprises at least an e-paper display and a multimedia display, that when executed by one or more processors, cause the one or more processors to perform the steps of: identifying, by the multi-display device, an enriched e-book source, wherein the enriched e-book source comprises text for presenting by the e-paper display of the multi-display device and at least a keyword referring to at least a supplemental material for the text for presenting by the multimedia display of the multi-display device; presenting, by the e-paper display of the multi-display device, at least a first keyword, the first keyword referring to a first supplemental material for a first portion of the text for presenting by the multimedia display of the multi-display device; receiving, by the multi-display device, a user input that selects to present the first supplemental material for the first keyword by the multimedia display of the multi-display device; in response to receiving the user input, retrieving, by the multi-display device, the first supplemental material for the first keyword; and presenting, by the multimedia display of the multi-display device, the first supplemental material for the first keyword.

The foregoing and other described implementations can each, optionally, include one or more of the following features.

A first feature, combinable with any of the following features, wherein the multimedia display comprises one or more of a Light-Emitting Diode (LED) display, a Liquid Crystal Display (LCD), an Organic Light-Emitting Diode Display (OLED), a colored e-paper display, or an audio output device.

A second feature, combinable with any of the previous or following features, wherein the first supplemental material for the first keyword comprises one or more of a picture, an audio, a video, a flash, a formula, or a second portion of the text.

A third feature, combinable with any of the previous or following features, wherein the first keyword comprises a Unique Resource Identifier (URI) referring to the first supplemental material for the first keyword for presenting by the multimedia display; and wherein retrieving the first supplemental material for the first keyword comprises retrieving the first supplemental material for the first keyword based on the URI referring to the first supplemental material for the first keyword.

A fourth feature, combinable with any of the previous or following features, wherein retrieving the first supplemental material for the first keyword comprises retrieving the first supplemental material for the first keyword locally from the multi-display device.

A fifth feature, combinable with any of the previous or following features, wherein the user input includes one or more of a touch, gesture, eye activity, or voice.

A sixth feature, combinable with any of the previous or following features, further including presenting, by the e-paper display of the multi-display device, a second keyword, the second keyword referring to a second supplemental material for a second portion of the text for presenting by the multimedia display of the multi-display device or by an output device external to the multi-display device; receiving, by the multi-display device, a second user input that selects to present the second supplemental material for the second keyword by the output device external to the multi-display device; and in response to receiving the second user input, instructing, by the multi-display device, the output device external to the multi-display device to present the second supplemental material for the second keyword.

A seventh feature, combinable with any of the previous or following features, wherein the multi-display device further includes user inference sensing components; wherein the user inference sensing components include one or more of a touchscreen, a camera, a gesture sensor, a motion sensor, a eye activity sensor, a microphone, a speaker, or an infra-red sensor; and wherein the user inference sensing components configured to receive the user input that selects to present the first supplemental material for the first keyword by the multimedia display of the multi-display device.

An eighth feature, combinable with any of the previous or following features, wherein the multi-display device further includes a second multimedia display, wherein the one or more processors execute the instructions to present the first keyword by presenting the first portion of the text and a first icon indicating that the first supplemental material for the first keyword is available for presenting by the second multimedia display of the multi-display device.

A ninth feature, combinable with any of the previous or following features, wherein the operations further include receiving, by the multi-display device, a second user input that selects to present the first supplemental material for the first keyword by the second multimedia display of the multi-display device; and in response to receiving the second user input, presenting, by the second multimedia display of the multi-display device, the first supplemental material for the first keyword.

A tenth feature, combinable with any of the previous or following features, wherein the operations further include presenting, by the e-paper display of the multi-display device, a second keyword, the second keyword referring to a second supplemental material for a second portion of the text for presenting by the multimedia display of the multi-display device or by an output device external to the multi-display device; receiving, by the multi-display device, a third user input that selects to present the second supplemental material for the second keyword by the output device external to the multi-display device; and in response to receiving the third user input, instructing, by the multi-display device, the output device external to the multi-display device to present the second supplemental material for the second keyword.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., or less than 5 secs. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a Central Processing Unit (CPU), an Field Programmable Gate Array (FPGA), or an Application-Specific Integrated Circuit (ASIC). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM), or both. The elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data includes all forms of non-volatile memory, media, and memory devices, including by way of example semiconductor memory devices, for example, Erasable Programmable Read-Only Memory (EPROM), Electrically Erasable Programmable Read-Only Memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a Cathode Ray Tube (CRT), Liquid Crystal Display (LCD), Light Emitting Diode (LED), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a number of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a Local Area Network (LAN), a Radio Access Network (RAN), a Metropolitan Area Network (MAN), a Wide Area Network (WAN), Worldwide Interoperability for Microwave Access (WIMAX), a Wireless Local Area Network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any disclosure or on the scope of what may be claimed, but rather as descriptions of features that may be specific to particular implementations of particular disclosures. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A method for providing an enriched e-reading experience in a multi-display environment (MDE), comprising:
identifying, by a multi-display device that comprises at least an e-paper display and a multimedia display, an enriched e-book source, wherein the enriched e-book source comprises text for presenting by the e-paper display of the multi-display device and at least one keyword referring to at least one supplemental material for presenting by the multimedia display of the multi-display device;
presenting, by the e-paper display of the multi-display device, a first keyword, the first keyword in a first portion of the text referring to a first supplemental material for presenting by the multimedia display of the multi-display device;
receiving, by the multi-display device, a user input that selects to present the first supplemental material for the first keyword by the multimedia display of the multi-display device;
in response to receiving the user input, retrieving, by the multi-display device, the first supplemental material for the first keyword; and
presenting, by the multimedia display of the multi-display device, the first supplemental material for the first keyword.

2. The method of claim 1, wherein the multimedia display comprises one or more of a Light-Emitting Diode (LED) display, a Liquid Crystal Display (LCD), an Organic Light-Emitting Diode Display (OLED), a colored e-paper display, or an audio output device.

3. The method of claim 1, wherein the first supplemental material for the first keyword comprises one or more of a picture, an audio, a video, a flash, a formula, or a second portion of the text.

4. The method of claim 1, wherein the first keyword comprises a Unique Resource Identifier (URI) referring to the first supplemental material for the first keyword for presenting by the multimedia display; and
retrieving the first supplemental material for the first keyword comprises retrieving the first supplemental material for the first keyword based on the URI referring to the first supplemental material for the first keyword.

5. The method of claim 1, wherein retrieving the first supplemental material for the first keyword comprises retrieving the first supplemental material for the first keyword locally from the multi-display device.

6. The method of claim 1, wherein the user input comprises one or more of a touch, gesture, eye activity, or voice.

7. The method of claim 1, wherein presenting the first keyword comprises presenting the first portion of the text and a first icon indicating that the first supplemental material for the first keyword is available for presenting by the multimedia display of the multi-display device.

8. The method of claim 7, further comprising:
presenting, by the e-paper display of the multi-display device, a second keyword, the second keyword referring to a second supplemental material for a second portion of the text for presenting by the multimedia display of the multi-display device or by an output device external to the multi-display device;
receiving, by the multi-display device, a second user input that selects to present the second supplemental material for the second keyword by the output device external to the multi-display device; and
in response to receiving the second user input, instructing, by the multi-display device, the output device external to the multi-display device to present the second supplemental material for the second keyword.

9. A multi-display device that comprises:
an e-paper display;
a multimedia display;
a non-transitory memory storage comprising instructions; and
one or more processors in communication with the memory, wherein the one or more processors execute the instructions to:
identify, by a multi-display device that comprises at least an e-paper display and a multimedia display, an enriched e-book source, wherein the enriched e-book source comprises text for presenting by the e-paper display of the multi-display device and at least one keyword referring to at least one supplemental material for the text for presenting by the multimedia display of the multi-display device;
present, by the e-paper display of the multi-display device, a first keyword, the first keyword in a first portion of the text referring to a first supplemental material for presenting by the multimedia display of the multi-display device;
receive, by the multi-display device, a user input that selects to present the first supplemental material for the first keyword by the multimedia display of the multi-display device;
in response to receiving the user input, retrieve, by the multi-display device, the first supplemental material for the first keyword; and
present, by the multimedia display of the multi-display device, the first supplemental material for the first keyword.

10. The multi-display device of claim 9, wherein the multimedia display comprises one or more of a Light-Emitting Diode (LED) display, a Liquid Crystal Display (LCD), an Organic Light-Emitting Diode Display (OLED), a colored e-paper display, or an audio output device.

11. The multi-display device of claim 9, wherein the first supplemental material for the first keyword comprises one or more of a picture, an audio, a video, a flash, a formula, or a second portion of the text.

12. The multi-display device of claim 9, wherein the first keyword comprises a Unique Resource Identifier (URI) referring to the first supplemental material for the first keyword for presenting by the multimedia display; and
retrieving the first supplemental material for the first keyword comprises retrieving the first supplemental material for the first keyword based on the URI referring to the first supplemental material for the first keyword.

13. The multi-display device of claim 9, comprising:
a first operating system that is associated with the e-paper display; and
a second operating system that is associated with the multimedia display;
wherein the first operating system is same or different from the second operating system.

14. The multi-display device of claim 9, further comprising user inference sensing components; wherein:
the user inference sensing components comprise one or more of a touchscreen, a camera, a gesture sensor, a motion sensor, an eye activity sensor, a microphone, a speaker, or an infra-red sensor; and
the user inference sensing components configured to receive the user input that selects to present the first supplemental material for the first keyword by the multimedia display of the multi-display device.

15. The multi-display device of claim 9, further comprising a second multimedia display, wherein the one or more processors execute the instructions to present the first keyword by presenting the first portion of the text and a first icon indicating that the first supplemental material for the first keyword is available for presenting by the second multimedia display of the multi-display device.

16. The multi-display device of claim 15, wherein the one or more processors execute the instructions to:
receive, by the multi-display device, a second user input that selects to present the first supplemental material for the first keyword by the second multimedia display of the multi-display device; and
in response to receiving the second user input, present, by the second multimedia display of the multi-display device, the first supplemental material for the first keyword.

17. The multi-display device of claim 9, wherein the one or more processors execute the instructions to:
present, by the e-paper display of the multi-display device, a second keyword, the second keyword referring to a second supplemental material for a second portion of the text for presenting by the multimedia display of the multi-display device or by an output device external to the multi-display device;
receive, by the multi-display device, a third user input that selects to present the second supplemental material for the second keyword by the output device external to the multi-display device; and
in response to receiving the third user input, instruct, by the multi-display device, the output device external to the multi-display device to present the second supplemental material for the second keyword.

18. A non-transitory computer-readable medium storing computer instructions for providing an enriched e-reading experience by a multi-display device that comprises at least an e-paper display and a multimedia display, that when executed by one or more processors, cause the one or more processors to perform the steps of:
identifying, by the multi-display device, an enriched e-book source, wherein the enriched e-book source comprises text for presenting by the e-paper display of the multi-display device and at least a keyword referring to at least a supplemental material for the text for presenting by the multimedia display of the multi-display device;
presenting, by the e-paper display of the multi-display device, at least a first keyword, the first keyword referring to a first supplemental material for a first portion of the text for presenting by the multimedia display of the multi-display device;
receiving, by the multi-display device, a user input that selects to present the first supplemental material for the first keyword by the multimedia display of the multi-display device;
in response to receiving the user input, retrieving, by the multi-display device, the first supplemental material for the first keyword; and
presenting, by the multimedia display of the multi-display device, the first supplemental material for the first keyword.

19. The non-transitory computer-readable medium of claim 18, wherein the first supplemental material for the first keyword comprises one or more of a picture, an audio, a video, a flash, a formula, or a second portion of the text.

20. The non-transitory computer-readable medium of claim 18, wherein retrieving the first supplemental material for the first keyword comprises retrieving the first supplemental material for the first keyword based on a URI referring to the first supplemental material for the first keyword remotely over a communication network or retrieving the first supplemental material for the first keyword locally from the multi-display device.
